(19) United States
(12) Patent Application Publication
(10) Pub. No.: US 2017/0035245 A1
(43) Pub. Date: Feb. 9, 2017

(54) GRILL HAVING MULTI-PIECE DRIP PAN

(71) Applicant: The Coleman Company, Inc., Wichita, KS (US)

(72) Inventors: Curtis Smith, Olathe, KS (US); Lucas Eck, Garden Plain, KS (US); Christopher K. Childers, Evergreen, CO (US)

(73) Assignee: The Coleman Company, Inc., Wichita, KS (US)

(21) Appl. No.: 15/304,509

(22) PCT Filed: Apr. 16, 2015
(86) PCT No.: PCT/US2015/026115

§ 371 Date: Oct. 14, 2016

Related U.S. Application Data
(60) Provisional application No. 61/980,087, filed on Apr. 16, 2014.

(51) Int. Cl. A47J 37/07

(52) U.S. Cl. CPC A47J 37/0786

(57) ABSTRACT

A multi-piece removable drain pan for a cooking device such as a grill, the drain pan comprising at least first and second portions, each portion comprising a channel having side walls capable of retaining a liquid therein even when said pan portion is in a tilted orientation, the at least first and second portions abutting each adjacent portion to fit within the cooking cavity of the grill.

### CROSS-REFERENCES TO RELATED APPLICATIONS

The present application claims the benefit of U.S. Provisional Application No. 61/980,087, filed on Apr. 16, 2014, the full disclosure of which is incorporated herein by reference.

### BACKGROUND

Portable cooking appliances have grown in popularity over the years. There are a number of types of portable cooking appliances commonly used: gas cooking appliances, electric cooking appliances and solid guel cooking appliances. Gas cooking appliances employ at least one burner to cook food that is supported on a grate above the burner(s). The fuel source for gas grills is typically liquid propane or natural gas. Electric cooking appliances can utilize an electric heating element integrated into the cooking surface but the cooking surface can include a grate-like element similar to a gas grill. Solid fuel cooking appliances similarly can utilize solid fuel such as charcoal and the like wherein the solid fuel is located under a grate which supports the food. A drawback in cooking with these types of portable cooking appliances is the grease and food drippings created by the food during cooking. These drippings can splatter on the inside bottom of the appliance, making cleanup difficult. Drip pans can be used in these portable cooking appliances, but the unitary pieced drip pans currently known and used are not easily removed from the cooking appliance without spilling the grease and food drippings. Additionally, the known unitary piece drip pans are not easily cleaned. What is needed is a multi-piece drip pan which can be easily removed from the cooking appliance in separate pieces without spilling any grease or food drippings and which can be easily placed in a dishwasher or otherwise cleaned because of its smaller construction.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A removable drip pan for a cooking device such as a grill, the drip pan comprising at least two separate and distinct pans, each pan having a channel defined by side walls capable of retaining liquid within said channel when said pan is in a tilted or non-tilted orientation, each pan abutting the adjacent pan when installed within a cavity of a cooking device.

In certain embodiments described herein, the drip pan utilizes two generally “U” shaped pans which form an oval shape when installed within a cavity of a cooking device.

For a fuller understanding of the nature and advantages of the present invention, reference should be made to the ensuing detailed description and accompanying drawings.

### BRIEF DESCRIPTION OF THE DRAWINGS

FIG. 1 shows an exploded view of a grill having a drip pan of the present invention.

FIG. 2 shows a top view of the drip pan FIG. 1, shown with a grill grate in reference lines on half of the drip pan.

FIG. 3 shows atop view of one half of the drip pan of FIG. I.

FIG. 4 shows a cut away view of the drip pan of FIG. 3, taken along lines 4-4.

### DETAILED DESCRIPTION

in the following description, various embodiments of the present invention will be described. For purposes of explanation, specific configurations and details are set forth in order to provide a thorough understanding of the embodiments. It will also be apparent to one skilled in the art, however, that the present invention may be practiced without the specific details. Furthermore, well-known features may be omitted or simplified in order not to obscure the embodiment being described.

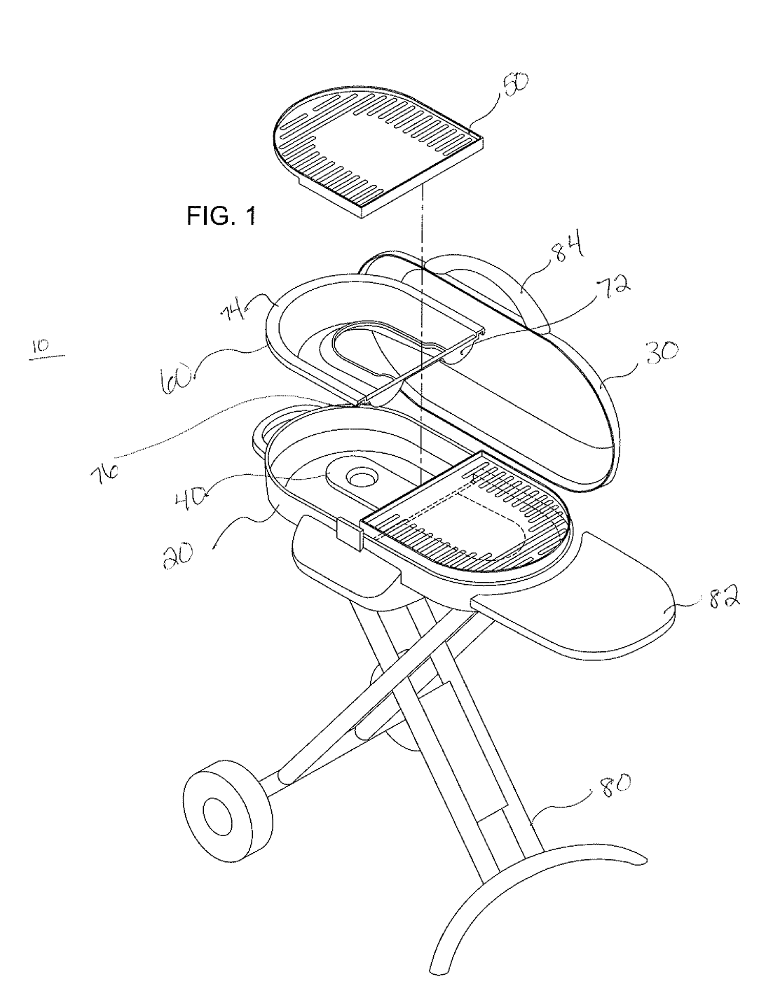

Referring now to the drawings, in which like reference numerals represent like parts throughout the several views, FIG. 1 shows a portable grill 10 having a removable, multi-piece drip pan. The grill 10 comprises a housing 20, lid 30, burner assembly 40, cooking surface 50 and drip pan 60. Grill 10 can be a conventional grill known in the current art, having the conventional working parts and construction for the housing, burner assembly, cooking surface and lid. As shown in FIG. 1, burner assembly 40, cooking surface 50 and drip pan 60 are located within the interior cavity of grill 10. Burner assembly 40 is located underneath at least a portion of drip pan 60 and drip pan 60 is located underneath the cooking surface 50. As shown in the figures, at least a portion of the drip pan resides below the burner line and the burner assembly is above at least a portion of the drip pan channels. In the present invention, cooking surface is preferably a slotted grate although other types of cooking surfaces are within the scope of the present invention such as a griddle, a pan, a perforated surface and the like. Cooking surface 50 in FIG. 1 is depicted as being 2 separate pieces but could also be a single piece cooking surface as long as it is removable from the interior of the grill to provide access to drip pan 60.

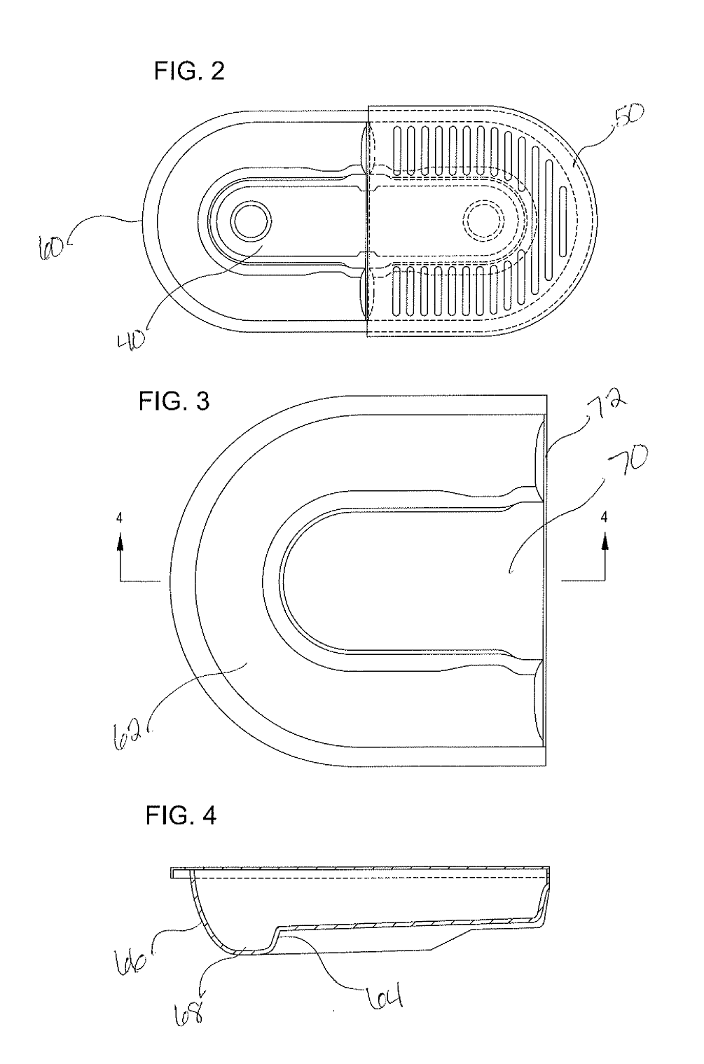

Drip pan 60 is shaped and configured to fit within the body or frame of the grill 60. As depicted in FIGS. 1-4, drip pan 60 is oval so as to fit within the shape of the grill housing 20 depicted herein but drip pan 60 could be any shape which corresponds to the shape of the grill housing such as rectangular, square, round and so on. Drip pan 60 preferably comprises two distinct and separate sections 60a, 60b. For purposes of explanation, only section 60a will be described herein but it should be understood that section 60b is identical in construction. As shown in FIGS. 1-4, drip pan section 60a comprises channel 62, center opening 70 and channel stops 72.

Channel 62 is generally “U” shaped such that when drip pan sections 60a and 60b are installed within grill cavity, they form a generally oval shape within the oval shaped grill depicted in the figures. Channel 62 comprises inner side wall 64, outer side wall 66 and lower portion 68 which form channel 62, which is preferably curved as shown in FIGS. 1 and 4. Inner side wall 64 is preferably shorter in height than outer side wall 66 as outer side wall extends up to the top edge of the grill housing 20. The free edge of outer side wall comprises upper lip 74 which extends over the upper edge of grill housing 20 and also comprises outer lip edge 76 which extends around the perimeter of grill housing 20 and serves to secure drip pan 60 in place within grill housing. Upper lip 74 and outer lip edge 76 define the exterior perimeter of the drip pan 60.

The end of drip pan 60a opposite the curved portion of the “U” shape (e.g. the end closest the center of the grill) comprises channel stops 72, which are shown herein to be straight. Channel stops 72 allow the interior ends of drip pan 60a, 60b to abut each other. It is within the scope of the present invention for drip pan 60a, 60b to connect to each other (not shown) at or around channel stops 72 but this is not required. The lower portion 68 of the pan retains the food drippings and water/grease mixture, assisted in the retention by inner side walls 64, outer side walls 66 and channel stops 72. Channel stops 72 serve to retain the water/grease mixture in the channels 62 even when each pan piece is removed from the grill and even if each pan piece is tilted during the removal process.

As described above, drip pan 60 preferably comprises two sections 60a, 60b. It is also within the scope of the present invention, however, for drip pan 60 to comprise more than two pieces provided each piece comprises inner and outer side walls and channel stops and provided that each piece abuts each adjacent drip pan piece. If the grill is other than oval shaped, channel 62 would be correspondingly altered in shape to fit within the grill cavity. Similarly, if there are more than two pieces for drip pan, all of the pieces will not necessarily be symmetrical but should be configured to abut the next adjacent piece and still fit within the interior cavity of the grill housing.

Drip pan 60 is dishwasher safe and small enough to fit in a dishwasher so that further cleaning is simple. Drip pan 60 is preferably made of a material that allows for repeated use due to its ability to be cleaned and to withstand the cleaning process. Suitable materials would include aluminum, stamped steel with a nonstick coating and other metallic materials. It is also within the scope of the invention for drip pan 60 to be comprised of a material that allows only a single use after which the pan can be easily disposed of. Such materials would include pressed cardboard, aluminum foil, non-flammable liner materials and wax paper.

Drip pan 60 is placed underneath the cooking surface 50 and collects grease or food drippings created during cooking. The addition of the removable drip pan 60 enables easier cleaning of the grill and its parts due to the ability to remove the pan in separate pieces and dispose of the water and grease mixture without spilling the contents- even if the drip pan 60 is tilted during removal. The pan 60 may have water placed in it prior to use such that during use the water in the pan quenches grease or food drippings that have caught on fire, effectively reducing the amount of flare ups in the cooking unit. The multi-piece pan allows for water to be added to the pan before the pan is placed in the grill as the pan can be tilted and still not spill the contents of the pan.

Grill 10 may also comprise a stand 80 as well as optional shelves 82, a handle 84 and other accessories known in the art. Grill 10 will also comprise controls (not shown) and if a fueled appliance, will also include a fuel canister and appropriate valves and connections (not shown).

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A drip collection pan for a cooking device, comprising:
A first generally “U” shaped pan having a curved section and two generally parallel legs defining a first channel having sidewalls and having a first stop located at an open end of said first leg and a second stop located at an open end of said second leg, said channel sidewalls and first and second stops capable of retaining a liquid within said first channel;
A second generally “U” shaped pan, separate and independent from said first pan, said second generally “U” shaped pan having a curved section and two generally parallel legs defining a second channel having sidewalls and having a first stop located at an open end of said first leg and a second stop located at an open end of said second leg, said channel sidewalls and first and second stops capable of retaining a liquid within said second channel;
Wherein said first stop of said first generally “U” shaped pan abuts said first stop of said second generally “U” shaped pan, and said second stop of said first generally “U” shaped pan abuts said second stop of said generally “U” shaped pan to form a general oval shape having an opening in a center area between said first “U” shapes pan legs and said second “U” shaped pan legs.

2. The drip collection pan of claim 1 wherein said first “U” shaped pan is removably attached to said second “U” shaped pan.

3. A drip collection pan for a cooking device, comprising:
At least two separate and independent pans, each of said pans comprising channels and each of said channels comprising side walls and stops capable of retaining a liquid within said channel even when said pan is in a tilted orientation;
Wherein said at least two separate pans abut each adjacent pan and wherein all pans are configured to fit within a cavity of cooking device when installed in said adjacent manner.

4. A cooking device comprising:
A grill having a housing defining a cavity therein;
A heat source within said cavity;
A cooking surface located above said heat source; and
A drip pan located at least partially between said heat source and said cooking surface, said drip pan comprising at least two separate and independent pans, each of said pans comprising channels and each of said channels comprising side walls capable of retaining a liquid within said channel even when said pan is in a tilted orientation, wherein said at least two separate pans abut each adjacent pan and wherein all pans are configured to removably fit within said cavity when installed in said adjacent manner.

5. The cooking device of claim 4, wherein said drip pan further comprises a generally oval shape when in said adjacent configuration.
